(19) United States
(12) Patent Application Publication
(10) Pub. No.: US 2020/0196641 A1
(43) Pub. Date: Jun. 25, 2020

(54) Sterilizing Agent Becoming Edible and/or Drinkable By Heat Treatment After Used For Sterilization

(71) Applicant: Separator System Industry Co., Ltd., Nara (JP)

(72) Inventors: Daisuke Matsuzawa, Nara (JP); Kozaburo Matsuzawa, Nara (JP); Nobuyuki Yamaji, Nara (JP); Sunao Kubota, Nara (JP); Tadashi Takatsuka, Nara (JP); Masatoshi Wada, Nara (JP)

(73) Assignee: Separator System Industry Co., Ltd.

(21) Appl. No.: 16/714,157

(22) Filed: Dec. 13, 2019

(30) Foreign Application Priority Data
Dec. 20, 2018 (JP) 2018-238820

(51) Int. Cl. A23L 3/3553; A23L 3/3508; A23L 3/358

(52) U.S. Cl. CPC A23L 3/3553; A23V 2002/00; A23L 3/358; A23L 3/3508

(57) ABSTRACT

Provided herein is a sterilizing agent which is edible and/or drinkable after used for sterilization, has an excellent sterilizing effect in a neutral pH range and high safety for a human body, and can be suitably used as a sterilizing agent or an additive for an object such as various liquids, solids, or foods and drinks. The sterilizing agent according to the present invention comprises a strong acidic food additive and a strong alkali salt.

### CROSS-REFERENCE TO RELATED APPLICATION

This patent application claims priority to Japanese Patent Application No. 2018-238820, filed in Japan Patent Office on Dec. 20, 2018, which application is incorporated in its entirety here by this reference.

### TECHNICAL FIELD

The present invention relates to a sterilizing agent becoming edible and/or drinkable after used for sterilization. More specifically, it relates to a sterilizing agent which becomes edible and/or drinkable after used for sterilization and has an excellent sterilizing effect in a neutral pH range and high safety for a human body.

### BACKGROUND

Various sterilizing agents and bactericides having less detrimental effects on a human body have been invented. These sterilizing agents and bactericides have been used for disinfection or sterilization of fresh foods such as fishes and shellfishes or used as a food additive for various foods.

For example, Japanese Unexamined Patent Application Publication No. 8-289768 discloses a food sterilizing material for sterilization and bacteriostatic treatment of fresh foods such as fresh fishes and shellfishes or vegetables and fruits. More specifically, the food sterilizing material of Japanese Unexamined Patent Application Publication No. 8-289768 comprises two or more of edible acid, a salt thereof, and ethanol for the purpose of sterilization and bacteriostatic treatment of fresh foods such as fresh fishes and shellfishes or vegetables and fruits.

Additionally, Japanese Patent No. 4594159 discloses an edible sterilizing agent which is highly safe for a human body and allows industrial production at a low cost with high quality. More specifically, the edible sterilizing agent of Japanese Patent No. 4594159 consists of citric acid, alcohol, and electrolyzed water, wherein the concentration of citric acid is 0.5 wt. % or more, the alcohol concentration is less than 40 wt. %, pH is less than 3, and the oxidation-reduction potential is 0 to 300 mV.

“Mizu to kassei-sanso (Water and Active Oxygen) (in Japanese)” (Seimei, Free Radical, Kankyou Kenkyuukai (Society of Life, Free Radical, Environment) ed., Ohmsha, Ltd) discloses an antimicrobial effect of pseudo acid water prepared by adding hydrochloric acid and sodium hydroxide to a sodium hypochlorite solution (see Tables 4-8) on page 148 of “Mizu to kassei-sanso”). According to “Water and Active Oxygen”, acidic pH increases the antimicrobial effect while pH closer to neutral negates the antimicrobial effect and requires more time for sterilization.

### SUMMARY

As described above, there have been disclosed mixtures comprising organic acid, alcohol, etc. for sterilization and sterilization of foods, dishes, etc. Since theses mixtures are supposed to be used at pH in an acidic region or an alkaline region to provide its sterilization and sterilization effect, they have a difficulty to provide the sterilization/sterilization effect on bacteria which are resistant to acidity and alkalinity. In addition, they have a risk of changing taste of foods when they are added in an acidic pH region or an alkaline pH region, thereby spoiling taste, flavor, or smell of the foods.

Thus, it is generally believed that it is necessary to adjust pH of conventional sterilizing agents to acidic side or alkali side to achieve a sufficient sterilizing effect. The inventors found out that a mixture comprising a strong acidic food additive and a strong alkali salt has a brilliant sterilizing effect in a neutral pH range where a sufficient sterilizing effect is traditionally difficult to achieve.

The present invention intends to solve the above-mentioned problems of prior art, and provides an edible and/or drinkable sterilizing agent which is subjected to a heating process to make it edible and/or drinkable after used for sterilization and has an excellent sterilizing effect in a neutral pH range and high safety for a human body.

The invention of first aspect relates to an edible and/or drinkable sterilizing agent, comprising a strong acidic food additive and a strong alkali salt, wherein the sterilizing agent is subjected to a heating process to make it edible and/or drinkable after used for sterilization, the strong acidic food additive is one or more selected from a group consisting of citric acid and sodium metaphosphate and the strong alkali salt comprises at least percarbonate.

The invention of second aspect relates to the sterilizing agent according to the first aspect, wherein the strong acidic food additive is citric acid and sodium metaphosphate and the strong alkali salt is Na2CO3, NaHCO3, and percarbonate.

The invention of third aspect relates to the sterilizing agent according to the first or second aspects, wherein the sterilizing agent is used in a neutral pH range.

The invention of fourth aspect relates to the sterilizing agent according to any one of the first to third aspects, wherein the sterilizing agent is granular or powdered.

The invention of fifth aspect relates to the sterilizing agent according to any one of the first to fourth aspects, wherein the strong acidic food additive is included at 0.1 wt. % to 6 wt. % of the whole sterilizing agent and the strong alkali salt is included at 0.1 wt. % to 6 wt. % of the whole sterilizing agent.

The invention of sixth aspect relates to a food and drink comprising the sterilizing agent according to any one of the first to fifth aspects.

The invention of seventh aspect relates to a method for eradicating an object, comprising a step of adding the sterilizing agent according to any one of the first to fifth aspects to the object, wherein the sterilizing agent is used in a neutral pH range; and a step of heating the sterilizing agent.

### Effects of the Invention

According to the invention of the first aspect, the sterilizing agent comprises a strong acidic food additive and a strong alkali salt, wherein the strong acidic food additive is one or more selected from a group consisting of citric acid and sodium metaphosphate, and wherein the strong alkali salt comprises at least percarbonate, thereby achieving an excellent sterilizing effect in a neutral pH range and usable as the edible and/or drinkable sterilizing agent highly safe for a human body due to a heating process after used for sterilization. The sterilizing agent provides an excellent sterilizing effect in a neutral pH range, thereby providing a brilliant sterilizing effect on bacteria which are resistant to acidity and alkalinity. Further, since the sterilizing agent provides an excellent sterilizing effect in a neutral pH range, it is excellent in handleability, causes little change in taste when being added to foods, and can be applied to a wide variety of foods.

According to the invention of the second aspect, the strong acidic food additive is citric acid and sodium metaphosphate and the strong alkali salt is Na2CO3, NaHCO3, and percarbonate, thereby providing a more brilliant sterilizing effect in a neutral pH range.

According to the invention of the third aspect, the sterilizing agent is used in a neutral pH range, thereby more easily achieving the effect of the sterilizing agent according to first or second aspects. Additionally, it provides an excellent sterilizing effect in a neutral pH range so that it is excellent in handleability, causes little change in taste when being added to foods and drinks, and can be applied to a wide variety of foods and drinks.

According to the invention of the fourth aspect, the sterilizing agent is granular or powdered so that it is excellent in handleability, stability, and preservability and can more easily achieve the effect of the sterilizing agent according to any one of the first to third aspects.

According to the invention of the fifth aspect, the sterilizing agent comprises 0.1 wt. % to 6 wt. % of the strong acidic food additive relative to the whole sterilizing agent and 0.1 wt. % to 6 wt. % of the strong alkali salt relative to the whole sterilizing agent, such that it can provide the effect of the sterilizing agent of any one of the first to fourth aspects more easily in a neutral pH range.

According to the invention of the sixth aspect, it is possible to obtain a food and drink having the effect of the sterilizing agent according to any one of the first to fifth aspects by containing the sterilizing agent according to any one of the first to fifth aspects.

According to the invention of the seventh aspect, there is provided a method for eradicating an object, consisting of a step of adding the sterilizing agent according to any one of the first to fifth aspects to the object, wherein the sterilizing agent is used in a neutral pH range; and a step of heating the sterilizing agent, and wherein the method is highly safe for a human body and can be suitably used.

### BRIEF DESCRIPTION OF DRAWINGS

FIG. 1A is a picture showing a result of 24-hour culture using example 1, illustrating the culture result of Staphylococcus aureus.

FIG. 1B is a picture showing a result of 24-hour culture using example 1, illustrating the culture result of Escherichia coli.

FIG. 1C is a picture showing a result of 24-hour culture using example 1, illustrating the culture result of Burkholderia cepacia.

FIG. 2A is a picture showing a result of 24-hour culture using example 2, illustrating the culture result of Staphylococcus aureus.

FIG. 2B is a picture showing a result of 24-hour culture using example 2, illustrating the culture result of Escherichia coli.

FIG. 2C is a picture showing a result of 24-hour culture using example 2, illustrating the culture result of Burkholderia cepacia.

FIG. 3A is a picture showing a result of 24-hour culture using example 3, illustrating the culture result of Staphylococcus aureus.

FIG. 3B is a picture showing a result of 24-hour culture using example 3, illustrating the culture result of Escherichia coli.

FIG. 3C is a picture showing a result of 24-hour culture using example 3, illustrating the culture result of Burkholderia cepacia.

FIG. 4A is a picture showing a result of 24-hour culture using example 4, illustrating the culture result of Staphylococcus aureus.

FIG. 4B is a picture showing a result of 24-hour culture using example 4, illustrating the culture result of Escherichia coli.

FIG. 4C is a picture showing a result of 24-hour culture using example 4, illustrating the culture result of Burkholderia cepacia.

FIG. 5A is a picture showing a result of 24-hour culture using example 5, illustrating the culture result of Staphylococcus aureus.

FIG. 5B is a picture showing a result of 24-hour culture using example 5, illustrating the culture result of Escherichia coli.

FIG. 5C is a picture showing a result of 24-hour culture using example 5, illustrating the culture result of Burkholderia cepacia.

FIG. 6A is a picture showing a result of 24-hour culture using comparative example 1, illustrating the culture result of Staphylococcus aureus.

FIG. 6B is a picture showing a result of 24-hour culture using comparative example 1, illustrating the culture result of Escherichia coli.

FIG. 6C is a picture showing a result of 24-hour culture using comparative example 1, illustrating the culture result of Burkholderia cepacia.

FIG. 7A is a picture showing a result of 24-hour culture using comparative example 2, illustrating the culture result of Staphylococcus aureus.

FIG. 7B is a picture showing a result of 24-hour culture using comparative example 2, illustrating the culture result of Escherichia coli.

FIG. 7C is a picture showing a result of 24-hour culture using comparative example 2, illustrating the culture result of Burkholderia cepacia.

FIG. 8A is a picture showing a result of 24-hour culture using comparative example 3, illustrating the culture result of Staphylococcus aureus.

FIG. 8B is a picture showing a result of 24-hour culture using comparative example 3, illustrating the culture result of Escherichia coli.

FIG. 8C is a picture showing a result of 24-hour culture using comparative example 3, illustrating the culture result of Burkholderia cepacia.

FIG. 9A is a picture showing a result of 24-hour culture using comparative example 4, illustrating the culture result of Staphylococcus aureus.

FIG. 9B is a picture showing a result of 24-hour culture using comparative example 4, illustrating the culture result of Escherichia coli.

FIG. 9C is a picture showing a result of 24-hour culture using comparative example 4, illustrating the culture result of Burkholderia cepacia.

FIG. 10A is a picture showing a result of 24-hour culture using comparative example 5, illustrating the culture result of Staphylococcus aureus.

FIG. 10B is a picture showing a result of 24-hour culture using comparative example 5, illustrating the culture result of Escherichia coli.

FIG. 10C is a picture showing a result of 24-hour culture using comparative example 5, illustrating the culture result of Burkholderia cepacia.

### DETAILED DESCRIPTION OF THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions and sequences may be accomplished by different embodiments that are also intended to be encompassed within the spirit and scope of the invention.

Explained below is a suitable embodiment of the sterilizing agent according to the present invention. In the specification, the neutral pH range refers to a pH range of 6-8. Additionally, pH in the acidic region refers to pH less than 6, while pH in the alkali region refers to pH more than 8. In the specification, “sterilization” means both reducing significant number of proliferous bacteria in an object and suppressing or inhibiting proliferation of bacteria.

The sterilizing agent according to the present invention comprises a strong acidic food additive and a strong alkali salt. The sterilizing agent according to the present invention does not comprise alcohol. Therefore, there is no risk of inflammation of skin, mucosa, etc. due to alcohol or smell of alcohol even if adding the sterilizing agent of the present invention to foods and drinks.

A strong acidic food additive used for the present invention is preferably, but not particularly limited to, one or more selected from a group consisting of citric acid and sodium metaphosphate to achieve an excellent sterilizing effect. Preferably, the strong acidic food additive comprises both citric acid and sodium metaphosphate to achieve more brilliant sterilization power. “Sodium metaphosphate” used in the present invention is a compound also referred to as ultraporin (ultrapoline), sodium ultraphosphate, or sodium acid metaphosphate. In addition to citric acid and sodium metaphosphate, a strong acidic food additive usable for the present invention is, not particularly limited to, phosphoric acid, polyphosphoric acid, fumaric acid, gluconic acid, adipic acid, lactic acid, glacial acetic acid, etc., for example.

It is preferable to contain 0.1 wt. % to 6 wt. % of a strong acidic food additive relative to the sterilizing agent according to the present invention (granule, powder, or liquid). Less than 0.1 wt. % of the strong acidic food additive is not preferable because it cannot provide the sufficient sterilizing effect. It is not preferable to contain more than 6 wt. % of the strong acidic food additive because it will not dramatically change the sterilizing effect but will increase the production cost. Hence, the content of the strong acidic food additive is preferably 0.1 wt. % to 6 wt. % which enables a sufficient as well as immediate and persistent sterilizing effect.

The sterilizing agent according to the present invention comprises a strong alkali salt in addition to a strong acidic food additive. The strong alkali salt according to the present invention is preferably, but not particularly limited to, one or more strong alkali salt selected from a group consisting of Na2CO3, NaHCO3, percarbonate (sodium percarbonate, potassium percarbonate, etc.), and salt water in terms of its excellent sterilizing effect. Na2CO3, NaHCO3, percarbonate, and a strong alkali salt except for Kansui (salt water, lye water, or brine) can also be used for the present invention. “Kansui” in the specification is a mixture of sodium carbonate and potassium carbonate, further comprising carbonate (sodium bicarbonate, etc.), pyrophosphate (tetrapotassium pyrophosphate, disodium dihydrogen pyrophosphate, tetrasodium pyrophosphate, etc.), polyphosphate (potassium polyphosphate, sodium polyphosphate, etc.), phosphate (tripotassium phosphate, dipotassium hydrogenphosphate, potassium dihydrogenphosphate, disodium phosphate, sodium dihydrogen phosphate, trisodium phosphate, etc.) and the like.

It is preferable to contain 0.1 wt. % to 6 wt. % of a strong alkali salt relative to the sterilizing agent according to the present invention (granule, powder, or liquid). If the content of the strong alkali salt is less than 0.1 wt. %, pH of the sterilizing agent according to the present invention remains in an acidic region and cannot be adjusted to a neutral range. Hence, it is not preferable. If the content of the strong alkali salt is more than 6 wt. %, pH of the sterilizing agent according to the present invention is in an alkali region and cannot be adjusted to a neutral range. Hence, it is not preferable. Therefore, the content of the strong alkali salt is preferably 0.1 wt. % to 6 wt. % so that it can be adjusted to a neutral pH range allowing a sufficient as well as immediate and persistent sterilizing effect.

The sterilizing agent according to the present invention is adjusted to pH of 6-8. The present invention can acquire an excellent sterilizing effect by blending an adequate amount of various strong acidic food additives and strong alkali salts as a neutralizing agent and dissolving it in a liquid such as tap water to adjust it to a neutral range. By adjusting pH to 6-8 in a neutral range, it is possible to obtain the sterilizing agent which has pH suitable for eating and drinking. pH more than 8 or less than 6 is not preferable because it is in an acidic region or an alkaline region not suitable for eating and drinking. Hence, the sterilizing agent according to the present invention is preferably adjusted to pH of 6-8. The sterilizing agent according to the present invention contains 0.1 wt. % to 6 wt. % of a strong acidic food additive and 0.1 wt. % to 6 wt. % of a strong alkali salt and has pH of 6-8 in a neutral range. pH of the sterilizing agent according to the present invention may be adjusted using a pH adjuster. The sterilizing agent according to the present invention can achieve a sterilizing effect even at pH in an acidic region or an alkaline region.

As described above, the sterilizing agent according to the present invention is used in a neutral pH range and has an excellent sterilizing effect in the neutral pH range. Therefore, it has an excellent sterilizing effect on bacteria and viruses which are resistant to pH in an acidic region and/or an alkaline region. Bacteria resistant to pH in an acidic region and/or an alkaline region include, for example, Staphylococcus aureus, Escherichia coli, Burkholderia cepacia and the like. Additionally, the sterilizing agent according to the present invention can be used in a neutral pH region, has an excellent handleability, and causes less changes in taste when being added to foods and drinks, thereby applicable to a wide variety of foods and drinks.

The sterilizing agent according to the present invention is preferably produced and stored in a granular or powdered state. The handleability, stability, and preservability of the sterilizing agent can be enhanced thanks to the granular or powdered state.

The sterilizing agent according to the present invention is usable as a sterilizing agent for any object, and efficient when being added, applied, or put to a liquid or solid, or added to foods and drinks. When the sterilizing agent according to the present invention is added to a liquid, solid, or foods and drinks, the amount to be added is not particularly limited and appropriately determined based on a type of an object. In one example, the sterilizing agent according to the present invention may be added such that its content is in a range of about 0.0005-50 wt. % relative to the object. When the sterilizing agent according to the present invention is dissolved in a liquid, the type of the liquid to which the sterilizing agent is resolved is not particularly limited, and any liquid such as pure water and tap water can be used. Additionally, the sterilizing agent according to the present invention can be used not only at room temperature but also any other temperature, before, during, or after being added to foods and drinks for sterilization. For example, the temperature may be raised after adding the sterilizing agent according to the present invention to foods and drinks for sterilization. For example, the sterilizing agent according to the present invention can be dissolved in a liquid such as water for sterilization, and then, the water can be heated and drank. Further, the sterilizing agent of the present invention can be added to rice for sterilization and then, the rice can be cooked.

### Examples

Below, examples of the present invention will be explained so that the effect of the sterilizing agent according to the present invention will be more obvious. The sterilizing agent according to the present invention is not limited to the following examples.

Preparation of Sterilizing Agents

At first, the sterilizing agents according to the present invention were prepared by the following procedure.

Citric acid, Na2CO3, NaHCO3, and sodium percarbonate were mixed to produce powders and the powders were dissolved in water (pure water) to prepare example A. In the example A, citric acid was 6 wt. %, Na2CO3 was 2 wt. %, NaHCO3 was 2 wt. %, and sodium percarbonate was 2 wt. %.

Citric acid and sodium percarbonate were mixed to produce powders and the powders were dissolved in water (pure water) to prepare example B. In the example B, citric acid was 6 wt. % and sodium percarbonate was 6 wt. %.

Sodium metaphosphate and sodium percarbonate were mixed to produce powders and the powders were dissolved in water (pure water) to prepare example C. In the example C, sodium metaphosphate was 6 wt. % and sodium percarbonate was 6 wt. %. pH value of the examples A, B, and C were 7, respectively.

For a comparative example 1, sterilized and purified water (pH: 7) was prepared.

To prepare a comparative example 2, disodium citrate dihydrate 1.5 hydrate (Na2HC6H5O71.5H2O) (6 wt. %, pH: 4.5) and water (pure water) were mixed.

To prepare a comparative example 3, trisodium citrate dihydrate (Na3C6H5O7-2H2O) (6 wt. %, pH: 8.5) and water (pure water) were mixed.

To prepare a comparative example 4, sodium dihydrogen citrate (NaH2C6H5O7) (6 wt. %, pH: 4.0) and water (pure water) were mixed.

To prepare a comparative example 5, sodium percarbonate (6 wt. %. pH: 10.5) and water (pure water) were mixed.

Comparative Test of Sterilization Effect

1 ml of test liquids of interest (examples A-C and comparative examples 1-5) were taken in a 1.5 ml Eppendorf tube, 0.025 ml of test bacterium liquid was added therein, and ardently stirred by a test tube mixer to be reacted for a predetermined period (30 or 60 seconds in the below test).

The test bacterium liquids contained Staphylococcus aureus, Escherichia coli, or Burkholderia cepacia respectively.

Three samples having a final concentration of 1 wt. %, 2 wt. %, and 5 wt. % respectively in a stirred solution were prepared from the example A.

A sample having a final concentration of lwt. % in the stirred solution is referred to as example 1, 2 wt. % is example 2, and 5 wt. % is example 3.

A sample having a final concentration of 1 wt. % in the stirred solution was prepared from the example B. It is referred to as example 4.

A sample having a final concentration of 1 wt. % in the stirred solution was prepared from the example C. It is referred to as example 5.

For the comparative examples 1-5, samples having a final concentration of 1 wt. % in the stirred solution were prepared.

Immediately after the end of the reaction, 0.15 ml of the stirred solution was coated on a standard agar plate medium by pipetting.

The standard agar plate medium was cultured at 35° C. for 24 hours, and then the number of colonies appeared on the culturing surface to which the bacterium liquid was applied was counted to know the number of viable bacteria.

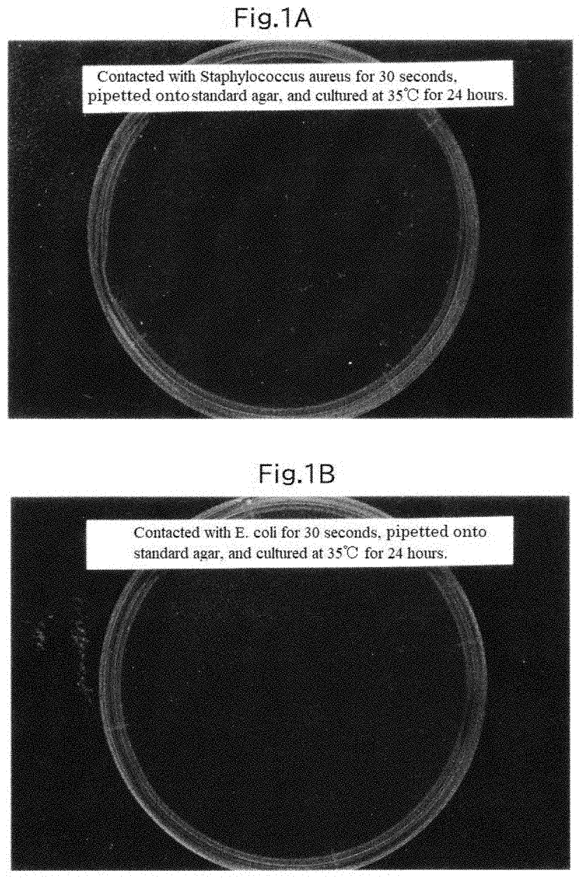

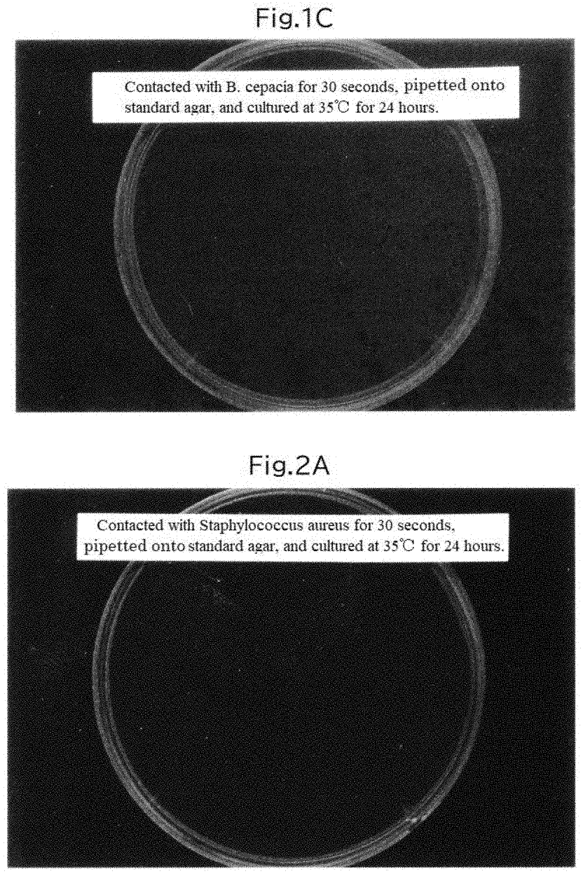

The results of the test are shown in FIGS. 1A-10C and Table 1.

FIG. 1A is a picture showing the result of 24-hour culture using the example 1, illustrating the culture result of Staphylococcus aureus.

FIG. 1B is a picture showing the result of 24-hour culture using the example 1, illustrating the culture result of Escherichia coli.

FIG. 1C is a picture showing the result of 24-hour culture using the example 1, illustrating the culture result of Burkholderia cepacia.

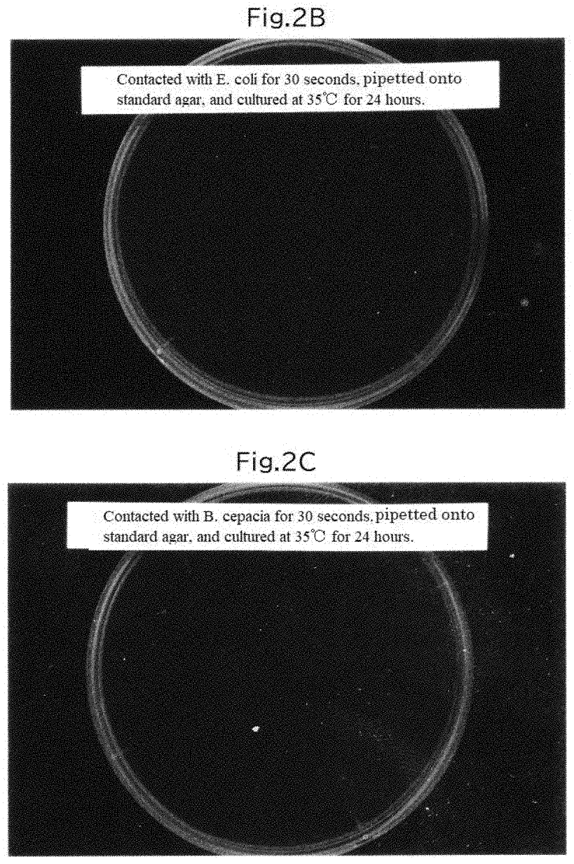

FIG. 2A is a picture showing the result of 24-hour culture using the example 2, illustrating the culture result of Staphylococcus aureus.

FIG. 2B is a picture showing the result of 24-hour culture using the example 2, illustrating the culture result of Escherichia coli.

FIG. 2C is a picture showing the result of 24-hour culture using the example 2, illustrating the culture result of Burkholderia cepacia.

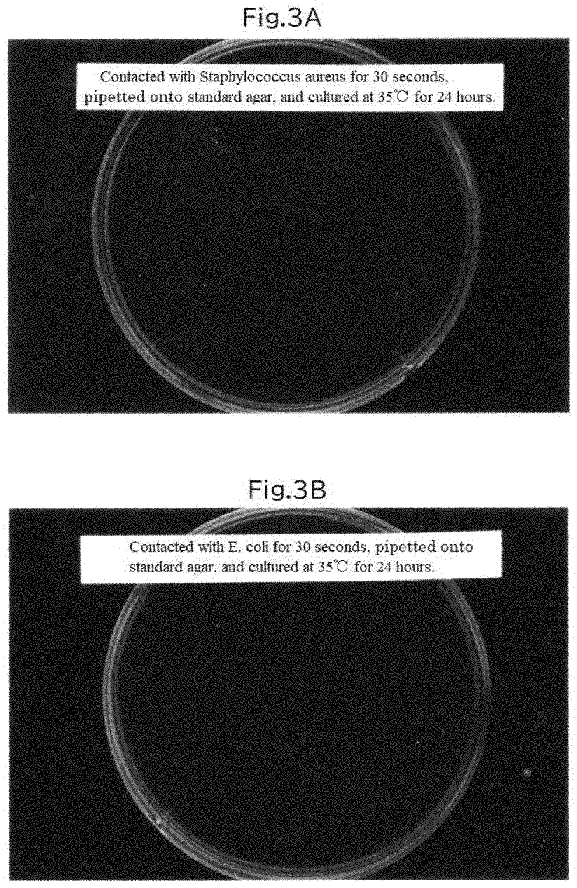

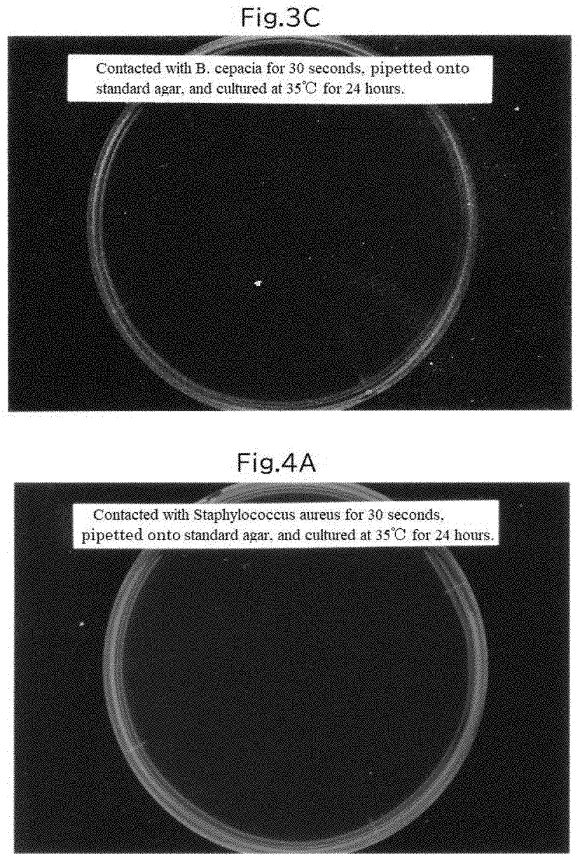

FIG. 3A is a picture showing the result of 24-hour culture using the example 3, illustrating the culture result of Staphylococcus aureus.

FIG. 3B is a picture showing the result of 24-hour culture using the example 3, illustrating the culture result of Escherichia coli.

FIG. 3C is a picture showing the result of 24-hour culture using the example 3, illustrating the culture result of Burkholderia cepacia.

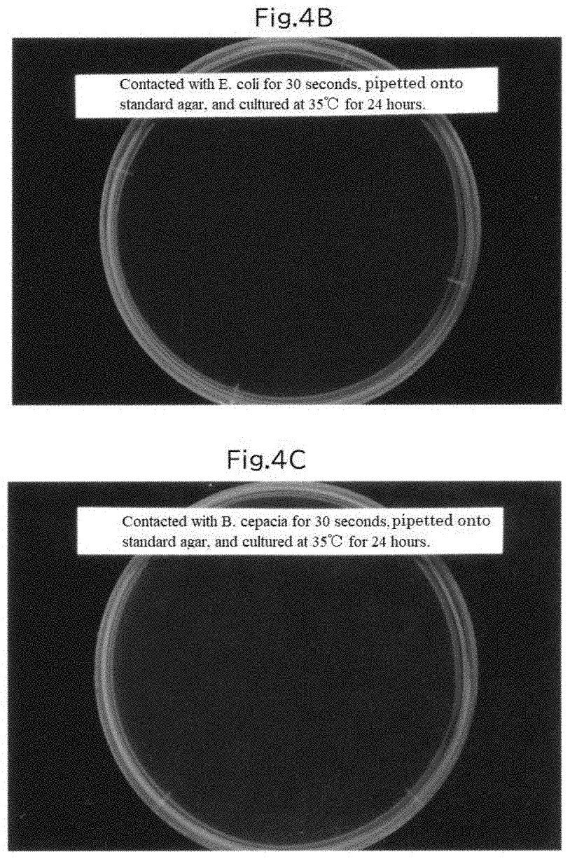

FIG. 4A is a picture showing the result of 24-hour culture using the example 4, illustrating the culture result of Staphylococcus aureus.

FIG. 4B is a picture showing the result of 24-hour culture using the example 4, illustrating the culture result of Escherichia coli.

FIG. 4C is a picture showing the result of 24-hour culture using the example 4, illustrating the culture result of Burkholderia cepacia.

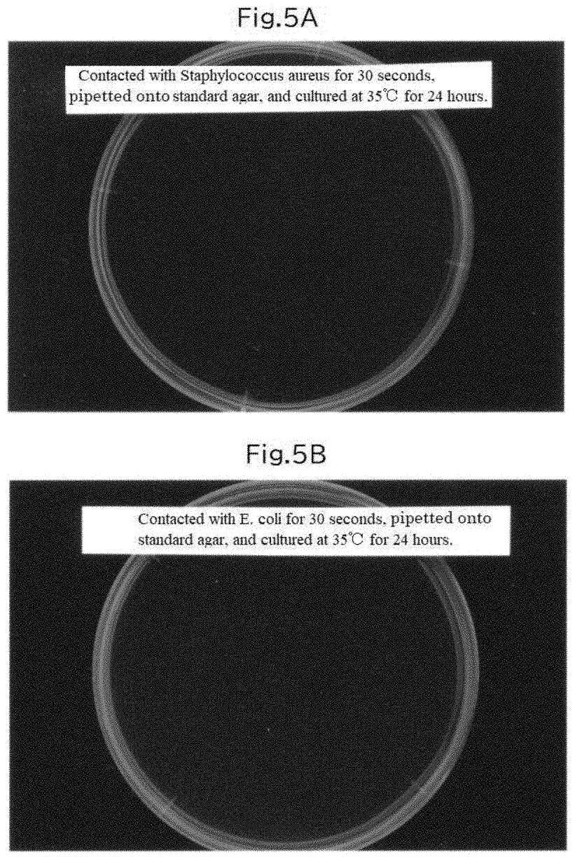

FIG. 5A is a picture showing the result of 24-hour culture using the example 5, illustrating the culture result of Staphylococcus aureus.

FIG. 5B is a picture showing the result of 24-hour culture using the example 5, illustrating the culture result of Escherichia coli.

FIG. 5C is a picture showing the result of 24-hour culture using the example 5, illustrating the culture result of Burkholderia cepacia.

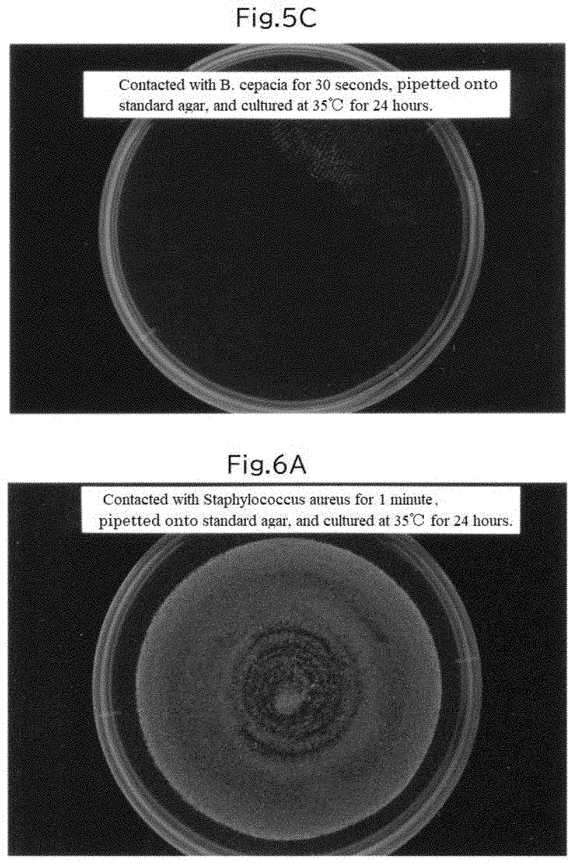

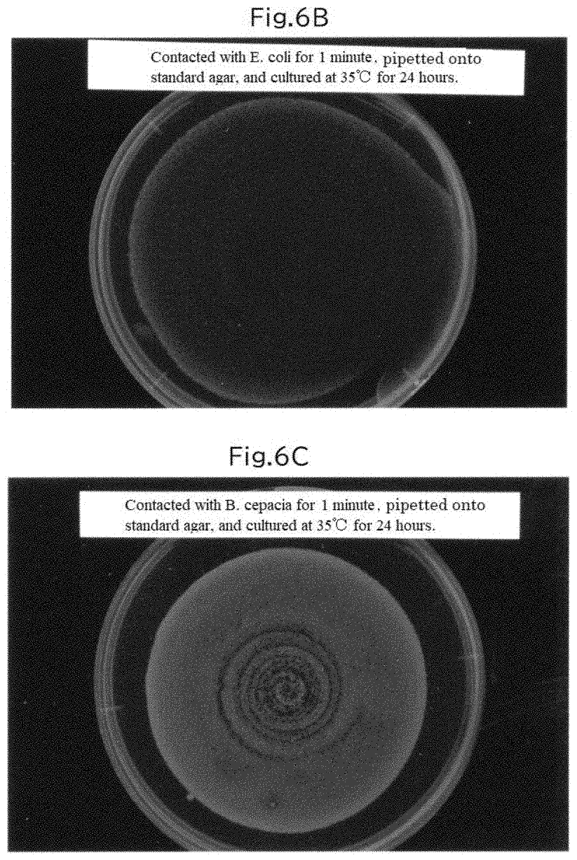

FIG. 6A is a picture showing the result of 24-hour culture using the comparative example 1, illustrating the culture result of Staphylococcus aureus.

FIG. 6B is a picture showing the result of 24-hour culture using the comparative example 1, illustrating the culture result of Escherichia coli.

FIG. 6C is a picture showing the result of 24-hour culture using the comparative example 1, illustrating the culture result of Burkholderia cepacia.

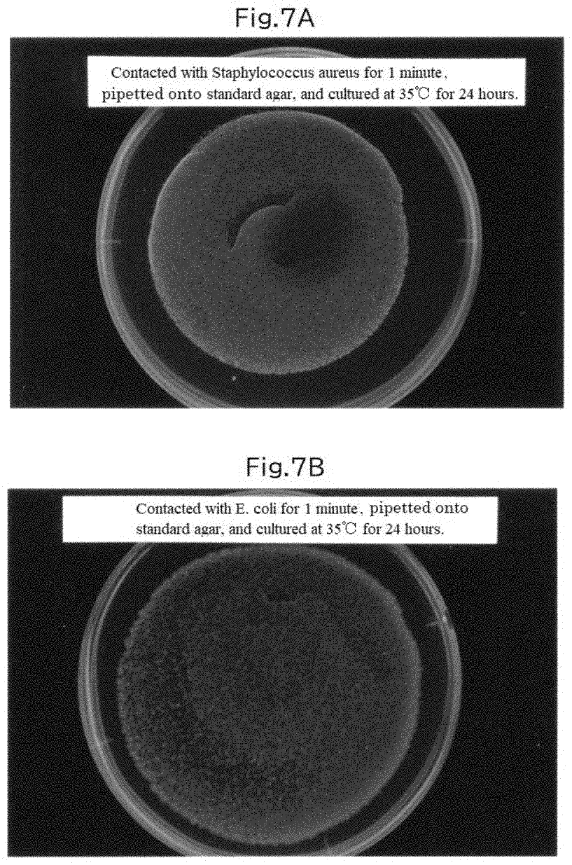

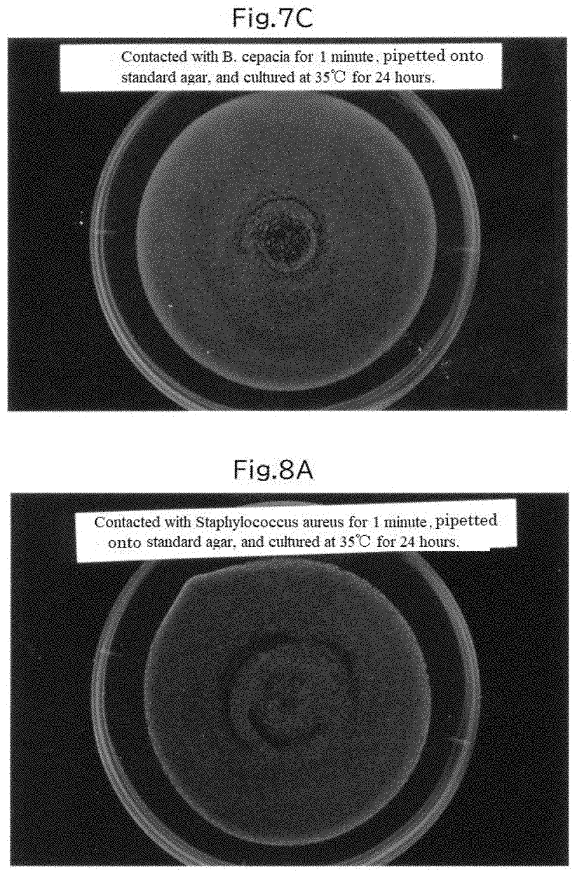

FIG. 7A is a picture showing the result of 24-hour culture using the comparative example 2, illustrating the culture result of Staphylococcus aureus.

FIG. 7B is a picture showing the result of 24-hour culture using the comparative example 2, illustrating the culture result of Escherichia coli.

FIG. 7C is a picture showing the result of 24-hour culture using the comparative example 2, illustrating the culture result of Burkholderia cepacia.

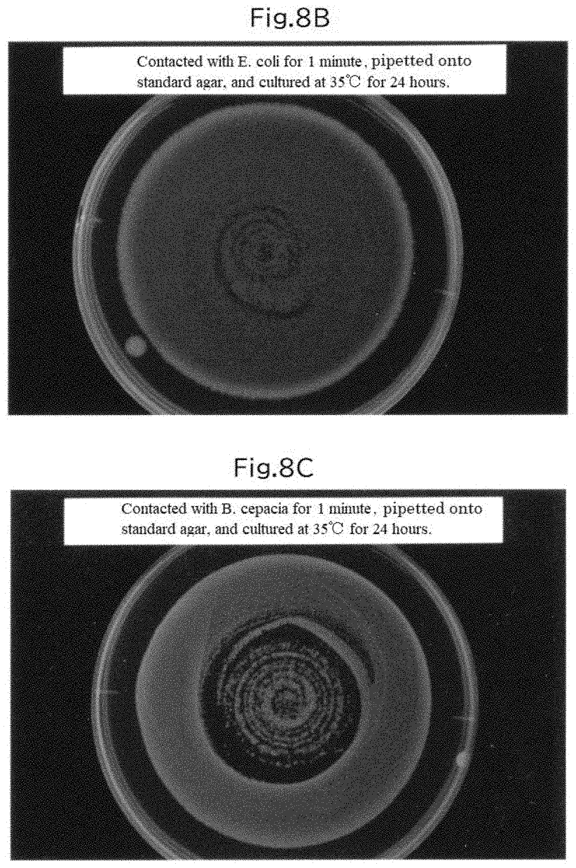

FIG. 8A is a picture showing the result of 24-hour culture using the comparative example 3, illustrating the culture result of Staphylococcus aureus.

FIG. 8B is a picture showing the result of 24-hour culture using the comparative example 3, illustrating the culture result of Escherichia coli.

FIG. 8C is a picture showing the result of 24-hour culture using the comparative example 3, illustrating the culture result of Burkholderia cepacia.

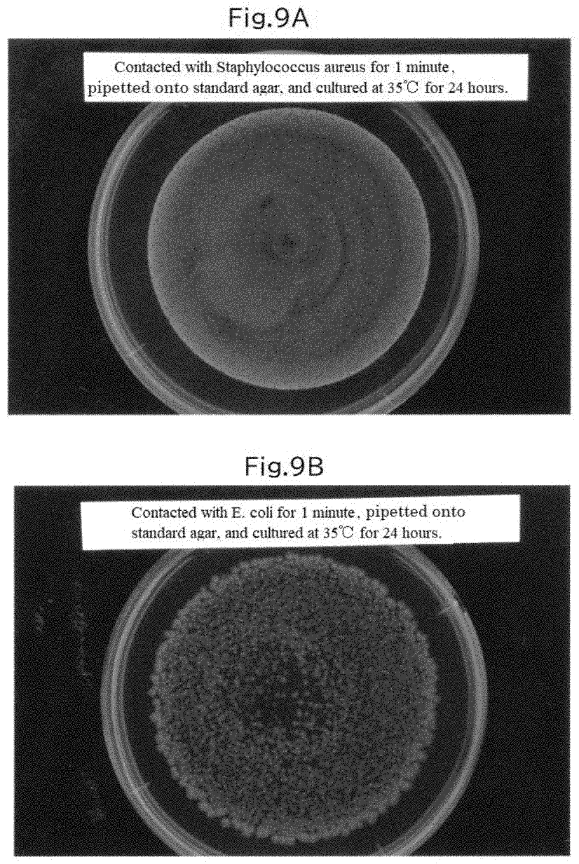

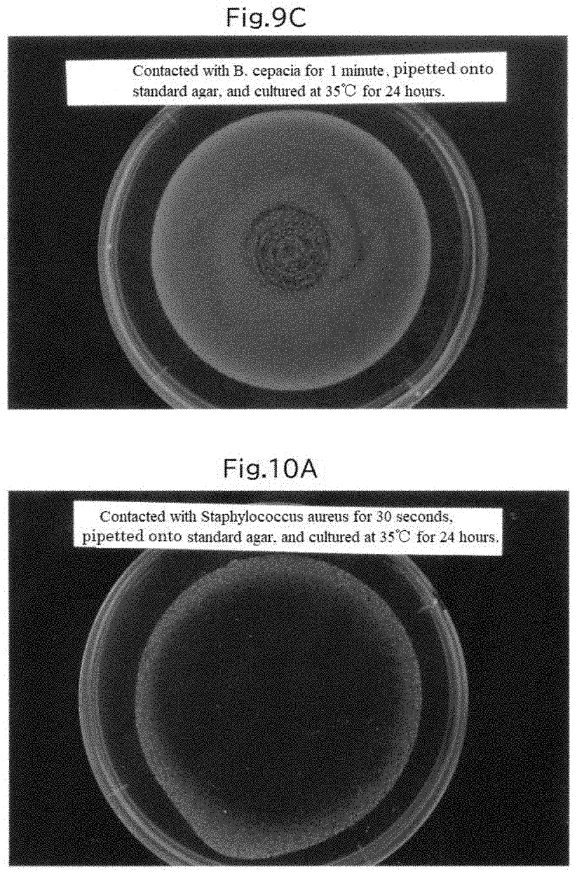

FIG. 9A is a picture showing the result of 24-hour culture using the comparative example 4, illustrating the culture result of Staphylococcus aureus.

FIG. 9B is a picture showing the result of 24-hour culture using the comparative example 4, illustrating the culture result of Escherichia coli.

FIG. 9C is a picture showing the result of 24-hour culture using the comparative example 4, illustrating the culture result of Burkholderia cepacia.

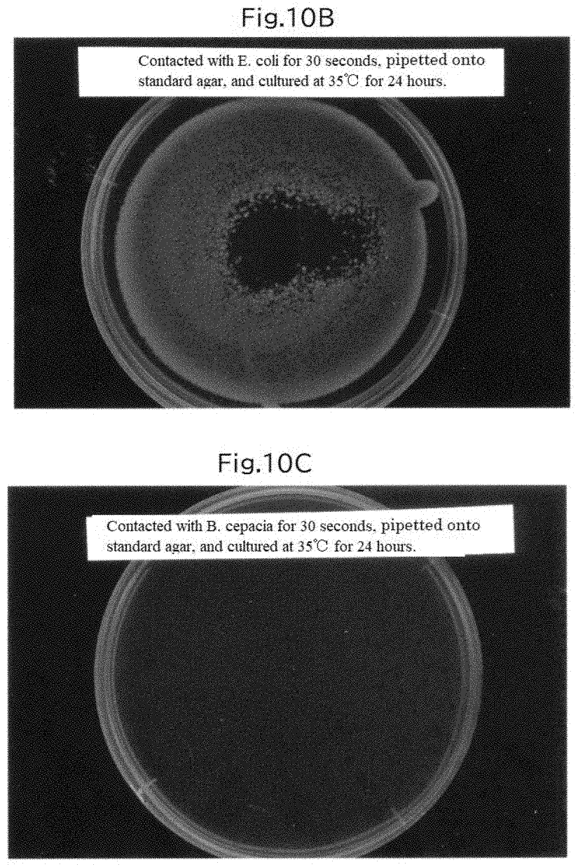

FIG. 10A is a picture showing the result of 24-hour culture using the comparative example 5, illustrating the culture result of Staphylococcus aureus.

FIG. 10B is a picture showing the result of 24-hour culture using the comparative example 5, illustrating the culture result of Escherichia coli.

FIG. 10C is a picture showing the result of 24-hour culture using the comparative example 5, illustrating the culture result of Burkholderia cepacia.

Table 1 shows the presence or absence of colonies; “−” means no colony, “+” means some colonies exist, “++” means many colonies exist, and “+++” means too many colonies exist.

As illustrated in FIGS. 1-10 and Table 1, no colony of Staphylococcus aureus, Escherichia coli, and Burkholderia cepacia was confirmed in the examples 1-5 after the 24-hour culture.

Therefore, it was found out that the examples 1-5 had an excellent sterilizing effect in a neutral pH range.

On the other hand, colonies of Staphylococcus aureus, Escherichia coli, and Burkholderia cepacia were confirmed in the comparative examples 1-4 after the 24-hour culture.

According to FIGS. 7-9, the comparative example 2 (pH 4.5), the comparative example 3 (pH 8.5), and the comparative example 4 (pH 4.0) contained citric acid like the present invention but had no sterilizing effect. It was found out that citric acid had no sterilizing effect in a non-neutral pH range.

According to FIG. 10, the comparative example 5 (pH 10.5) contained sodium percarbonate like the present invention, but had no sterilizing effect on Staphylococcus aureus and Escherichia coli.

These results showed that the comparative examples 1-5 did not have a sufficient sterilizing effect.

Further, only one component of the present invention, that is a strong acidic food additive or a strong alkali salt, did not provide a sufficient sterilizing effect, and the excellent sterilizing effect would be achieved by mixing and neutralizing them.

It is expected that the sterilizing agent according to the present invention achieves an excellent sterilizing effect by a neutralizing reaction to be neutral.

Further, it is expected that the excellent sterilizing effect of the sterilizing agent according to the present invention is caused by destruction of a cell surface layer, oxidization and degeneration of protein, and destruction of DNA and RNA chains.

TABLE 1

| | | | | | | Comparative | Comparative | Comparative | Comparative | Comparative |
|---|---|---|---|---|---|---|---|---|---|---|
| | Example 1 | Example 2 | Example 3 | Example 4 | Example 5 | Example 1 | Example 2 | Example 3 | Example 4 | Example 5 |
| Concentration | 1 | 2 | 5 | 1 | 1 | 1 | 1 | 1 | 1 | 1 |
| (wt. %) | | | | | | | | | | |
| Action time | 30 | 30 | 30 | 30 | 30 | 60 | 60 | 60 | 60 | 30 |
| (second) | | | | | | | | | | |
| Colonies | — | — | — | — | — | + + + | + + | + | + + + | + + |
| (Staphylococcus | | | | | | | | | | |
| aureus) | | | | | | | | | | |
| Colonies | — | — | — | — | — | + + | + + | + + | + + | + + + |
| (Escherichia coli) | | | | | | | | | | |
| Colonies | — | — | — | — | — | + + + | + + | + + | + + + | — |
| (Burkholderia | | | | | | | | | | |
| cepacia) | | | | | | | | | | |

### INDUSTRIAL APPLICABILITY

The sterilizing agent according to the present invention contains a strong acidic food additive and a strong alkali salt so that it can achieve an excellent sterilizing effect in a neutral pH range and high safety for a human body.

Therefore, the present invention can be suitably used as a sterilizing agent or an additive to an object such as various liquids, solids, or foods and drinks.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

What is claimed is:

1. An edible and/or drinkable sterilizing agent, comprising:
a strong acidic food additive; and
a strong alkali salt,
wherein the sterilizing agent is subjected to a heating process after used for sterilization to make it edible and/or drinkable,
the strong acidic food additive is one or more selected from a group consisting of citric acid and sodium metaphosphate, and
the strong alkali salt at least comprises percarbonate.

2. The sterilizing agent according to claim 1,
wherein the strong acidic food additive is citric acid and sodium metaphosphate,
and wherein the strong alkali salt is Na₂CO₃, NaHCO₃, and percarbonate.

3. The sterilizing agent according to claim 1, the sterilizing agent is used in a neutral pH range.

4. The sterilizing agent according to claim 1, the sterilizing agent is granular or powdered.

5. The sterilizing agent according to claim 1, the strong acidic food additive is included at 0.1 wt. % to 6 wt. % of the whole sterilizing agent, and the strong alkali salt is included at 0.1 wt. % to 6 wt. % of the whole sterilizing agent.

6. A food and drink comprising the sterilizing agent according to claim 1.

7. A food and drink comprising the sterilizing agent according to claim 2.

8. A food and drink comprising the sterilizing agent according to claim 3.

9. A food and drink comprising the sterilizing agent according to claim 4.

10. A food and drink comprising the sterilizing agent according to claim 5.

11. A method for eradicating an object, comprising:
adding the sterilizing agent according to claim 1 to the object, wherein the sterilizing agent is used in a neutral pH range; and
heating the sterilizing agent.

12. A method for eradicating an object, comprising:
adding the sterilizing agent according to claim 2 to the object, wherein the sterilizing agent is used in a neutral pH range; and
heating the sterilizing agent.

13. A method for eradicating an object, comprising:
adding the sterilizing agent according to claim 3 to the object, wherein the sterilizing agent is used in a neutral pH range; and
heating the sterilizing agent.

14. A method for eradicating an object, comprising:
adding the sterilizing agent according to claim 4 to the object, wherein the sterilizing agent is used in a neutral pH range; and
heating the sterilizing agent.

15. A method for eradicating an object, comprising:
adding the sterilizing agent according to claim 5 to the object, wherein the sterilizing agent is used in a neutral pH range; and
heating the sterilizing agent.

16. The sterilizing agent according to claim 2, the sterilizing agent is used in a neutral pH range.

17. The sterilizing agent according to claim 2, the sterilizing agent is granular or powdered.

18. The sterilizing agent according to claim 3, the sterilizing agent is granular or powdered.

19. The sterilizing agent according to claim 2, the strong acidic food additive is included at 0.1 wt. % to 6 wt. % of the whole sterilizing agent, and the strong alkali salt is included at 0.1 wt. % to 6 wt. % of the whole sterilizing agent.

20. The sterilizing agent according to claim 3, the strong acidic food additive is included at 0.1 wt. % to 6 wt. % of the whole sterilizing agent, and the strong alkali salt is included at 0.1 wt. % to 6 wt. % of the whole sterilizing agent.
